(19) United States
(12) Patent Application Publication
(10) Pub. No.: US 2025/0203033 A1
(43) Pub. Date: Jun. 19, 2025

(54) IMAGE PROCESSING WITHOUT COLOR CHANNEL CLIPPING

(71) Applicant: Arm Limited, Cambridge (GB)

(72) Inventors: David HANWELL, Sale (GB); Yanxiang WANG, Manchester (GB)

(21) Appl. No.: 18/543,371

(22) Filed: Dec. 18, 2023

(51) Int. Cl. H04N 1/60; G06T 5/92; G06T 7/90; G06V 10/56

(52) U.S. Cl. CPC H04N 1/60; G06T 5/92; G06T 7/90; G06V 10/56; G06T 2207/10024

(57) ABSTRACT

An image processing method processes color image data. The applies an operator to a representative pixel value to generate a transformed pixel value. A controlled gain is determined so that: if applying a gain based on the transformed pixel value to a maximum color channel value of the pixel will generate a color channel value that is below a threshold value, the controlled gain is determined based on the transformed pixel value and the representative pixel value, and if applying a gain based on the transformed pixel value to the maximum color channel value will generate a color channel value that is above the threshold value, the controlled gain is determined such that the maximum color channel value is mapped to a value representable by a predetermined number of bits. The controlled gain is applied to each of the color channel values.

### BACKGROUND OF THE INVENTION

### Field of the Invention

The present invention relates to image processing methods and image-processing apparatus. The methods and image-processing apparatus are configured to avoid color channel clipping during the image processing.

### Description of the Related Technology

Images have become an integral part of daily life. Cameras are embedded in many devices including smartphones, surveillance systems, and body cameras. Within these cameras, digital image sensors like charge-coupled devices (CCD) and complementary metal oxide semiconductor (CMOS) convert real-world scenes into digital images.

While these digital image sensors provide a digital representation of a captured scene, additional processing steps are often applied to enhance the overall quality of the captured digital images. This additional processing could involve reducing noise, refining contrast, and employing various techniques to elevate the perceived image quality.

Examples of digital image processing techniques for enhancing image quality include improving white balance, sharpening, and undertaking color mapping. Other digital image processing techniques are related to practical applications, such as compressing images for efficient storage and adapting digital images for display on specific hardware.

Some types of digital image processing perform a direct one-to-one mapping of pixel color values. For example, a sharpening operation may map RGB pixel values in an unprocessed image to RGB pixel values in a sharpened image. However other types of operators applied during image processing may be non-linear and risk clipping values in the image data. If the image processing is performed on a color-channel by color-channel basis, clipping may happen in fewer than all channels causing a color shift to occur. Techniques for mitigating clipping that may cause color shift during digital image processing are desirable.

### SUMMARY

According to a first aspect there is provided an image processing method that processes digital image data containing a plurality of pixel areas, each pixel area comprising a plurality of color channel values each represented by a predetermined number of bits, the method comprising, for each of the plurality of pixel areas: calculating a representative pixel value based on two or more of the plurality of color channel values; applying an operator to the representative pixel value to generate a transformed pixel value; determining a maximum color channel value that is the largest of the color channel values; determining a controlled gain so that: in a case that applying a gain based on the transformed pixel value to the maximum color channel value will generate a color channel value that is below a threshold value, the controlled gain is determined based on the transformed pixel value and the representative pixel value, and in a case that applying a gain based on the transformed pixel value to the maximum color channel value will generate a color channel value that is above the threshold value, the controlled gain is determined such that the maximum color channel value is mapped to a value representable by the predetermined number of bits; and applying the controlled gain to at least one of the color channel values in the pixel area.

According to a second aspect there is provided an image-processing apparatus configured to process digital image data containing a plurality of pixel areas, each pixel area comprising a plurality of color channel values each represented by a predetermined number of bits, the image processing apparatus comprising one or more hardware units configured to, for each of the plurality of pixel areas: calculate a representative pixel value based on two or more of the plurality of color channel values; apply an operator to the representative pixel value to generate a transformed pixel value; determine a maximum color channel value that is the largest of the color channel values; determine a controlled gain so that: in a case that applying a gain based on the transformed pixel value to the maximum color channel value will generate a color channel value that is below a threshold value, the controlled gain is determined based on the transformed pixel value and the representative pixel value, and in a case that applying a gain based on the transformed pixel value to the maximum color channel value will generate a color channel value that is above the threshold value, the controlled gain is determined such that the maximum color channel value is mapped to a value representable by the predetermined number of bits; and apply the controlled gain to at least one of the color channel values in the pixel area.

A non-transitory computer-readable storage medium storing instructions that, when executed by a processor of a device, causes the device to perform an image processing method that processes digital image data containing a plurality of pixel areas, each pixel area comprising a plurality of color channel values each represented by a predetermined number of bits, the method comprising, for each of the plurality of pixel areas: calculating a representative pixel value based on two or more of the plurality of color channel values; applying an operator to the representative pixel value to generate a transformed pixel value; determining a maximum color channel value that is the largest of the color channel values; determining a controlled gain so that: in a case that applying a gain based on the transformed pixel value to the maximum color channel value will generate a color channel value that is below a threshold value, the controlled gain is determined based on the transformed pixel value and the representative pixel value, and in a case that applying a gain based on the transformed pixel value to the maximum color channel value will generate a color channel value that is above the threshold value, the controlled gain is determined such that the maximum color channel value is mapped to a value representable by the predetermined number of bits; and applying the controlled gain to at least one of the color channel values in the pixel area.

### BRIEF DESCRIPTION OF THE DRAWINGS

Embodiments will be described below with reference to the accompanying drawings in which:

FIG. 1 is a schematic diagram showing components of an image processing device;

FIG. 2 is a flowchart showing steps in a method for applying an operator to color image data;

FIG. 3 is a flowchart showing steps for applying image processing to color image data; and

FIG. 4 is a graph illustrating a mapping applied to a maximum color channel value after a gain is applied to generate an output value.

### DETAILED DESCRIPTION OF CERTAIN INVENTIVE EMBODIMENTS

Embodiments relate to methods for avoiding clipping when performing image processing. In some examples, when performing image processing, an RGB image may be converted to an intensity image, also known as a grayscale image. This is conversion may be performed to reduce the dimensionality of the digital image data. Subsequent operations performed on the intensity image may have lower computational complexity than corresponding operations performed on each of the color channels of the original color image data.

In some cases, a gain may be determined based on the intensity image that is then applied to the color channel values in the original color image. However, such image processing methods can cause clipping of color channels and consequent color shifting.

An embodiment may provide an image processing method that processes digital image data containing a plurality of pixel areas, each pixel area comprising a plurality of color channel values each represented by a predetermined number of bits. The method may comprise, for each of the plurality of pixel areas calculating a representative pixel value based on two or more of the plurality of color channel values. An operator may be applied to the representative pixel value to generate a transformed pixel value. A maximum color channel value that is the largest of the color channel values may be determined. The method may include determining a controlled gain so that: in a case that applying a gain based on the transformed pixel value to the maximum color channel value will generate a color channel value that is below a threshold value, the controlled gain is determined based on the transformed pixel value and the representative pixel value, and in a case that applying a gain based on the transformed pixel value to the maximum color channel value will generate a color channel value that is above the threshold value, the controlled gain is determined such that the maximum color channel value is mapped to a value representable by the predetermined number of bits. The method may apply the controlled gain to at least one of the color channel values in the pixel area.

In some embodiments, the representative pixel value may be a weighted sum of two or more of the color channel values.

In some embodiments, the threshold value may be a maximum value expressible by the predetermined number of bits. In other embodiments the threshold value may be lower than the maximum value expressible by the predetermined number of bits.

In a case that applying a gain based on the transformed pixel value to the maximum color channel value will generate a color channel output value that is above the threshold value, the controlled gain may be set to a value that is a ratio of the maximum value representable by the predetermined number of bits divided by the maximum color channel value.

In some implementations, determining whether applying a gain based on the transformed pixel value to the maximum color channel value will generate a color channel value that is above the threshold value may include comparing one of: a product of the maximum color channel value and the transformed pixel value to a product of the maximum value expressible by the predetermined number of bits and the representative pixel value, and a product of the maximum color channel value and the transformed pixel value to the representative pixel value in a case that the maximum color channel value is represented as a normalized value. In such implementations, in a case that one of: the product of the maximum color channel value and the transformed pixel value is greater than the product of the maximum value expressible by the predetermined number of bits and the representative pixel value, and the product of the maximum color channel value and the transformed pixel value is greater than the representative pixel value, it may be determined that applying the gain based on the transformed pixel value to the maximum color channel value will generate a color channel value that is above the threshold value.

In other embodiments, the threshold may be lower than the maximum value expressible by the predetermined number of bits. In some such embodiments, in a case that applying a gain based on the transformed pixel value to the maximum color channel value will generate a color channel output value that is above the threshold value: an input value may be generated based on the maximum color channel value and a gain determined based on the transformed pixel value, the input value may be mapped to an output value, and the controlled gain may be determined based on the output value.

The input value may be generated as a product of the maximum color channel value and a gain calculated based on the transformed pixel value. In some implementations, the input value may be mapped to the output value using at least one selected from a group of: a linear function, a polynomial curve, Bezier spline, a piecewise linear function, a function represented in a look-up table, and an exponential curve.

The operator applied to the representative pixel value may be selected from a group of: a tone mapping operator, and a dehaze operator.

The pixel area may be a single pixel value. The digital image data may comprise red, green and blue color channels. In some such embodiments the representative pixel value may be a luma value.

In other implementations, the pixel area may be one of a two-by-two pixel area and a three-by-three pixel area of filter array image data. Each pixel in the pixel area may include a single value corresponding to one of a red, green and blue color channel value.

In some embodiments, applying the controlled gain to the color channel values in the pixel area may comprise interpolating controlled gains determined for adjacent pixel areas to determine interpolated gain values for a plurality of pixels in the pixel area and applying the determined interpolated gain values to the pixels in the pixel area.

The gain based on the transformed pixel value may be determined as a ratio of the transformed pixel value and the representative pixel value.

Applying the controlled gain may comprise applying the controlled gain to each of the color channel values in the pixel area.

According to a further embodiment there may be provided an image-processing apparatus configured to process digital image data containing a plurality of pixel areas, each pixel area comprising a plurality of color channel values each represented by a predetermined number of bits. The image processing apparatus may comprise one or more hardware units configured to, for each of the plurality of pixel areas, calculate a representative pixel value based on two or more of the plurality of color channel values. The operator may be applied to the representative pixel value to generate a transformed pixel value. Further a maximum color channel value may be determined that is the largest of the color channel values. A controlled gain may be determined so that: in a case that applying a gain based on the transformed pixel value to the maximum color channel value will generate a color channel value that is below a threshold value, the controlled gain is determined based on the transformed pixel value and the representative pixel value, and in a case that applying a gain based on the transformed pixel value to the maximum color channel value will generate a color channel value that is above the threshold value, the controlled gain is determined such that the maximum color channel value is mapped to a value representable by the predetermined number of bits. The controlled gain may be applied to at least one of the color channel values in the pixel area.

According to a further embodiment, a non-transitory computer-readable storage medium storing instructions may be provided that, when executed by a processor of a device, causes the device to perform an image processing method that processes digital image data containing a plurality of pixel areas, each pixel area comprising a plurality of color channel values each represented by a predetermined number of bits. The method may comprise, for each of the plurality of pixel areas, calculating a representative pixel value based on two or more of the plurality of color channel values. An operator may be applied to the representative pixel value to generate a transformed pixel value. A maximum color channel value may be determined that is the largest of the color channel values. Further a controlled gain may be determined so that: in a case that applying a gain based on the transformed pixel value to the maximum color channel value will generate a color channel value that is below a threshold value, the controlled gain is determined based on the transformed pixel value and the representative pixel value, and in a case that applying a gain based on the transformed pixel value to the maximum color channel value will generate a color channel value that is above the threshold value, the controlled gain is determined such that the maximum color channel value is mapped to a value representable by the predetermined number of bits. The controlled gain may be applied to at least one of the color channel values in the pixel area.

Methods described further below may be implemented in software on an image processing device or using an image processing device that uses fixed function hardware as will now be described.

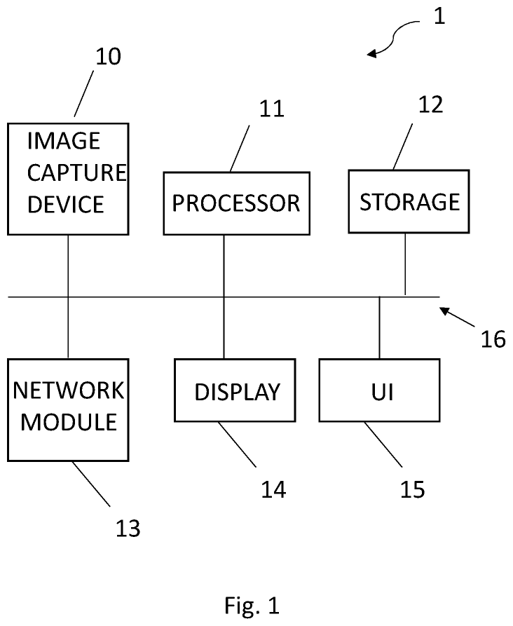

FIG. 1 is a schematic diagram of an image-processing device 1. The device comprises an image capture device 10, a processor 11, a storage 12, a network module 13, a display 14, and user interface 15. Components of the device are connected by a bus 16. The image capture device 10 may be a camera, image sensor such as CCD or CMOS sensor or the like configured to capture still images and/or video data. The processor 11 may be a central processing unit or other type of processing unit, and the storage 12 may be a memory device such as an SSD, a hard drive, or the like. The storage 12 may also include a temporary memory such as random access memory (RAM). The network module 13 may be a Wi-Fi® or other network module or mobile telecommunications module that allows the device to communicate over one or more wired or wireless networks. The device may be operable to send or receive image data via the network module 13. The display 14 may be an LED, OLED, micro-LED or other display that may be used to display information to a user of the device. The user interface 15 may take the form of a touch screen, keyboard, mouse, or other input device to allow a user to interact with the device. The depicted components are not essential, and the device may include other components not shown.

The image-processing device may in some examples be a mobile device such as a mobile phone or PDA. In other examples the device may be a computer such as a laptop or desktop PC. In other examples the device may be a server or cloud service. In some embodiments the image-processing device may be a hardware component such as a graphics processing unit (GPU) or an image signal processing component (not including all the features shown in FIG. 1). These examples are not exhaustive, and the device make take other forms not mentioned.

Any method described below may be implemented as a computer program. The computer program may be stored on a computer-readable storage medium and read by one or more information processing apparatus, such as the image-processing devices described above, for the purposes of performing such a method.

In further embodiments the methods below may be implemented in hardware and performed using fixed function circuitry. Fixed function circuitry may comprise dedicated hardware circuitry that is configured specifically to perform a fixed function, and that is not reconfigurable to perform a different function. In this way, the fixed function circuitry can be considered distinct from a programmable circuit that is configured to receive and decode instructions defined, for example, in a software program. For example, the fixed function circuitry may not be reconfigurable to perform another function.

Fixed-function circuitry may comprise at least one electronic circuit for performing an operation. Any fixed function circuitry may comprise application-specific integrated circuitry. The application-specific integrated circuitry may comprise one or more integrated circuits and may be designed using a hardware description language such as Verilog and implemented as part of the fabrication of an integrated circuit. The application-specific integrated circuitry may comprise a gate array or a full custom design.

The following methods are applied to digital image data. The digital image data is represented by pixel areas, each of which have a plurality of different color channels. In one example, each pixel area may comprise three color channels. The color channels may be red (R), green (G), and blue (B). In some implementations, each pixel area is a single pixel. In other implementations, the pixel area may be a two-by-two, three-by-three or other sized pixel area. The channels may represent color channels of a single pixel or may be color channel data corresponding to different pixel values in color filter array data, such as data from a Bayer filter array. In such color filter array data each pixel within an area also has an associated color so that color channel values associated with the pixel area can be identified.

The digital image data may be represented by a predetermined number of bits that can represent a range of values. For example, 8-bit image data is capable of representing 256 image values. As 8 bits are provided per color channel, for example, 8-bit image data is capable of representing in excess of 16 million colors due to the presence of three color channels. The value associated with the pixel area in each color channel may be referred to as a color channel value.

As briefly discussed above, in some cases it may be undesirable to directly apply a mapping or operator directly to color image pixel data. The operator may affect the different color channels unevenly and accordingly may alter the ratios between color channels, and thus change the colors of objects in a digital image. To avoid this problem, an image may be converted to an intensity image and a gain may be determined for each pixel area corresponding to the non-linear mapping or operator to be applied. The gain may subsequently be uniformly applied to each color channel by multiplying the color channel values by the gain value.

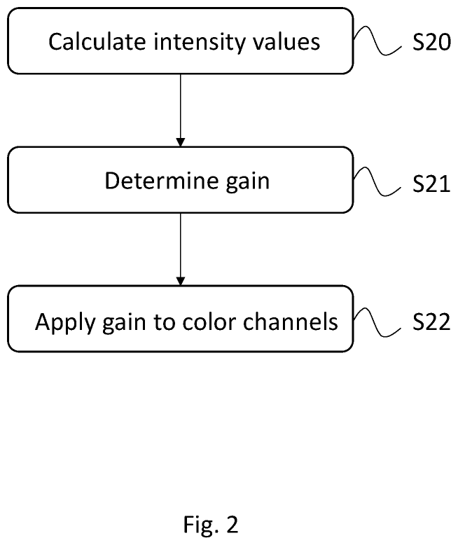

A color image may be converted to an intensity image in several different ways. However, in the context of converting color image data to allow application of an operator, intensity calculation algorithms come with respective advantages and drawbacks. FIG. 2 is a flowchart showing steps in a method for applying an operator to color image data.

In a first step, S20, representative pixel values for the image data may be determined. The representative pixel values may be intensity pixel values determined from color channels of the color image data. The intensity values may be calculated in different ways. In one example, the digital image data is R, G, B data and the intensity value is calculated as a weighted combination of the RGB channels. For example, the intensity values may be luma values.

The weighting of the R, G, and B values does not matter for the purpose of the embodiments. In one example, the luma may be calculated as Y=0.2126R+0.7152G+0.0722B, where R, G, and B are respective color channel values corresponding to the red, green and blue channels of the color image data. In other implementations, an evenly weighted intensity value may be used where Y=0.3333R+0.3333G+0.3333B.

In other embodiments, the representative pixel values may be determined as the maximum of color channel values of the RGB data (referred to herein as ‘MaxRGB’).

In step S21, a mapping corresponding to an operator to be applied may be applied to each representative pixel value, P, to generate a transformed pixel value, f(P). The mapping does not matter for the purposes of the embodiments. However, some examples could be a local contrast adjustment that is applied on a pixel area-by-pixel area basis or an operator to adjust intensity values to be within a predetermined range.

A gain for the pixel area may be determined by dividing the transformed pixel value, f(P) by the corresponding representative pixel value, P:

$$g = \frac{f ( P )}{P} \qquad formula 1$$

At the end of step S21, a gain has been determined. In step S22, the color channel values are then multiplied by the gain, g. Because the color channel values at each pixel area are multiplied by the same gain, this method applies an operator in a way that preserves ratios between color channels as long as the gain, g, is between 0 and 1. However, as explained further below, when the gain is greater than one (i.e. color channel values are increased) there is a risk of color channel clipping.

There are advantages in calculating the intensity value in different ways. For instance, creating an intensity image using the maximum color channel value as the intensity value (a so-called MaxRGB method) retains knowledge of each pixel area's largest color channel value. In a case that an operator is applied, which will apply modifications to the original image, knowledge of the largest color channel value can allow the method of applying the operator to mitigate unwanted effects such as color shift or artefacts. However, the maximum value in a color channel, M, is sensitive to noise in the image because a large color channel value due to noise may be used to determine the gain to be applied to all color channels. Accordingly, using the maximum color channel value that is the largest of the color channel values as the representative pixel value to which to apply a non-linear mapping function can result in image noise being enhanced, which is undesirable.

Generating the intensity image using a weighted intensity value, which is a weighted combination of the RGB values, is less susceptible to noise spikes because the weighted intensity value is calculated as an average over three color channels. Noise in one color channel value will therefore have a lower impact on the weighted intensity value. An intensity image generated based on the weighted intensity values also tends to provide a more accurate depiction of the pixel intensity for the Human Visual System. However, as now explained, the use of weighted intensity values may cause color shifts.

When applying a gain to the color channel values associated with a pixel area in step S22, there is a risk that color clipping will occur. Color clipping occurs when one color channel value is mapped to a value that is above the maximum that can be represented by the bit depth of image data (number of bits representing each color channel). The unrepresentable color channel value generated by applying the gain to the original color channel value is typically reduced to the maximum value that can be represented by the number of bits. When multiplying the color channel values by the gain in step S22, other channels may not exceed the maximum amount that can be represented by the bit depth in those channels. Accordingly, the other color channels may not be reduced by the same proportion causing the hue to change.

In one detailed example, an image of a bright red traffic light has 12-bit RGB values (3809, 1106, 1147). In this example the original image of the red traffic light has a ratio of red to green that is approximately 3.44. If, during application of an operator, a gain of 2.3 is applied to these pixels, to get RGB values (8761, 2544, 2631), the red color channel value may be reduced to 4095. The red channel is reduced because 8761 is above the maximum value that can be expressed in 12-bits, giving final RGB values of (4095, 2544, 2631). After applying the operator, the ratio of red to green becomes around 1.61, so the hue of the traffic light has changed considerably. If such an approach is adopted the red traffic light may appear to be much less red.

The maximal gain that can be applied at a pixel location without clipping a color channel value is gₘₐₓ:

$${g}_{max} = \frac{max pixel value}{M} \qquad formula 2$$

where M is the maximum color channel value and max pixel value is the maximum value representable by the number of bits in each color channel.

Embodiments will now be described that use a weighted intensity value, such as Luma, for the intensity value. However, these methods are adapted to mitigate the risk of clipping in color channels described above.

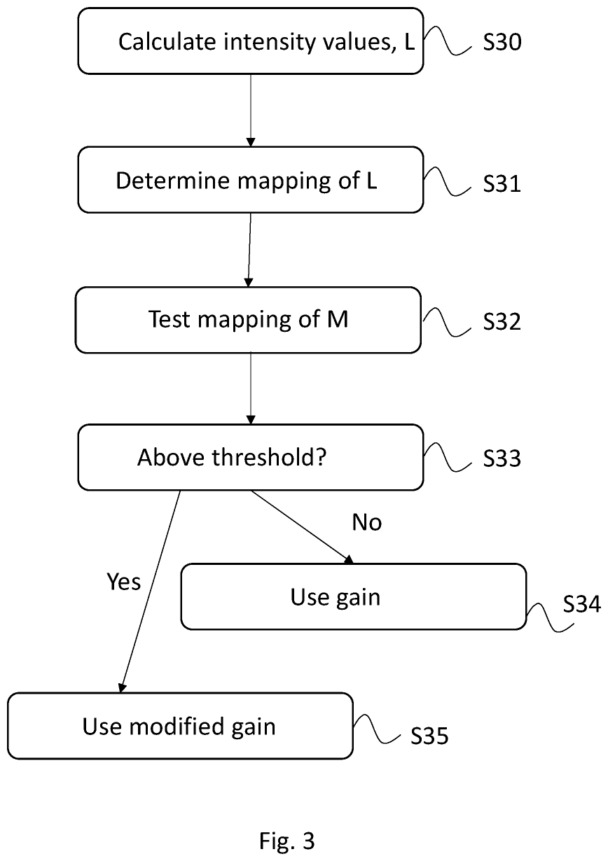

FIG. 3 is a flowchart showing steps for applying image processing to a digital image. In step S30, the color image data is processed to generate representative pixel values for the image data. As described above, the representative pixel values may be intensity pixel values, L, in an intensity image. More particularly, the intensity values may be weighted combinations of color channel values that form an intensity value. In one example, the digital image data is R, G, B data and the intensity value is calculated as a weighted combination of the RGB channels. The method below is applied to each pixel area of the digital image data.

In step S31, an operator is applied to representative pixel value, P, of the intensity values that applies a mapping to generate a transformed pixel value, f(P). The mapping is a function to be applied to the image data. Examples of such operators will be given further below.

In step 32, a maximum color channel value, M, is determined for a pixel area, which is the largest value taken by the color channel values associated with the pixel area. A test is applied to determine how the maximum color channel value would be mapped in a case that a gain is applied based on the transformed pixel value in step 31.

In step S33, it is determined whether the maximum color channel value would be mapped to a value that is larger than a threshold. Examples of this step will be given in more detail below.

In step S34, as the maximum color channel value would not be mapped to a value that is larger than the threshold, the method determines a controlled gain based on the transformed pixel value in step S31 and applies the same gain to each of the color channel values.

In step S35 as the maximum color channel value would be mapped to a value that is above the threshold, the controlled gain to be applied is determined based on a value other than the transformed pixel value determined in step S31 in order to reduce the gain.

At the end of the method shown in FIG. 3, the controlled gain is applied to the pixel area by multiplying each of the color channel values of the pixel area by the controlled gain. As the mapping of the maximum color channel value has been checked, the same gain is applied to each color channel value and the new color channel values all fall within a range representable by the digital image data, avoiding a shift in the hue of the pixel color.

### First Example Method (Soft Clipping)

As described above in connection with steps S30 and S31, a representative pixel value that may be an intensity value, L, is calculated from the color channels of each pixel area of the original image data. In step S31, the intensity value, L, is mapped using an operator to be applied to generate a transformed pixel value. Further, in step S32, a test is applied to the maximum color channel value to determine whether a gain based on the transformed pixel value would result in mapping the maximum color channel value outside of the representable range of the color channel.

In a first example, at step S32, a gain is calculated using the transformed pixel value. In particular, the gain is calculated using formula 1 described above. The gain for the pixel area is determined by dividing the transformed representative pixel value, f(P), by the corresponding original pixel value, P. The maximum color channel value is then multiplied by the calculated gain to generate an input value.

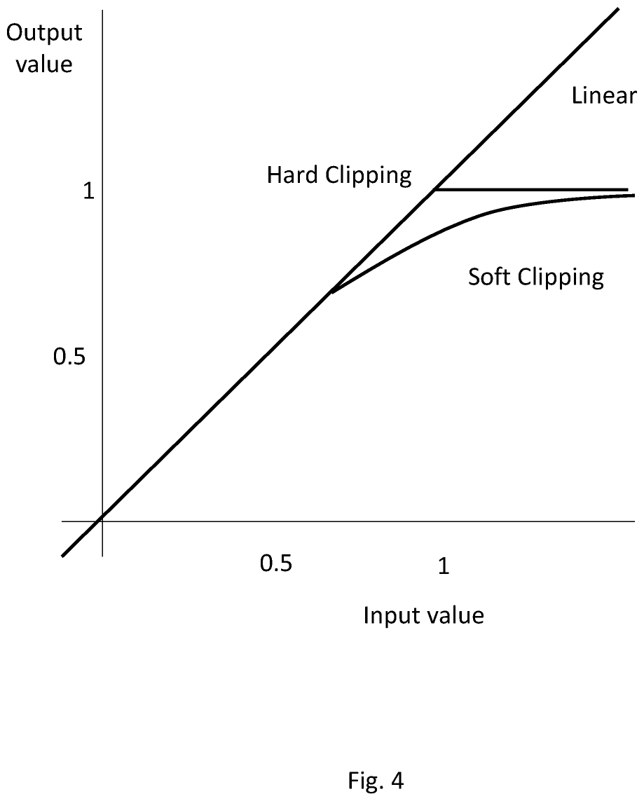

FIG. 4 is a graph, which is illustrative and not drawn to scale, showing a mapping applied to the maximum color channel value after the gain is applied (marked as ‘input value’ in FIG. 4) to generate an output value. The axes have been normalized such that the value 1 represents a maximum value, max pixel value, that may be represented by the number of bits that represent each color channel value. So, for example, for 8-bit processing the value 1 represents a value of 255 in the color channel.

FIG. 4 illustrates two implementations of the first example method. According to a first example, a hard clipping is applied. The line representing the mapping for hard clipping is linear between input values of 0 and 1. The value 1 may accordingly be referred to as the threshold value. In a case that the input value (maximum value multiplied by the gain) is above 1, the input value is above the maximum value that can be represented by the number of bits available per color channel. Accordingly, above 1, a hard clipping is applied in which the output value is set to 1.

According to a second implementation, also illustrated in FIG. 4, the input value is mapped linearly to the output value between input values of 0 and 0.7. In this second implementation, the value 0.7 may be referred to as the threshold value. Above an input value of 0.7, the gradient is reduced such that input values are no longer an identity mapping to the output value and input values above 1 can be mapped to output values that are less than or equal to 1.

The curve above an input value of 0.7 illustrated in FIG. 4 may be a Bezier curve, other polynomial curve or exponential curve. Further, in other implementations, a piece-wise linear function could be used such that the gradient below the threshold value of 0.7 is linear with a gradient of 1 and is linear with a gradient that is less than one above the threshold value until it reaches an output value of 1. After reaching the output value of 1, hard clipping may again be applied.

In the example shown in FIG. 4, the threshold value is shown as 0.7. However other threshold values may be used. In yet further implementations, the soft clipping may be combined with the hard clipping such that above a first threshold the output value increases less slowly than the input value and above a second threshold value a hard clipping is applied. That is to say that all values above the second threshold value may be mapped to an output value of 1 (representing the maximum representable value).

As can be seen from FIG. 4, according to the first example, if the gain when applied to the maximum color channel value generates an input value that is outside of the representable range, say to 1.2 times the maximum representable value, the output value remains within the representable range due to soft or hard clipping.

Accordingly, FIG. 4 shows that for cases in which the maximum color channel value would be mapped to well within the representable color range (in this example within the first 70% of the representable color channel values) no change is made. That is to say that the input value is equal to the output value.

In the implementations discussed above, for cases in which the input value is subject to either hard or soft clipping such that the output value is less than the input value, the mapping shown in FIG. 4 generates the output value. The mapping shown in FIG. 4 may be implemented using a function or by reference to a look-up table. A controlled gain is generated using the output value. The controlled gain is:

$$g = \frac{output value}{max color channel value} \qquad formula 3$$

where g is the gain, output value is the output value determined from the applying the mapping shown in FIG. 4 and max color channel value is the largest color channel value associated with the pixel area.

This controlled gain is then applied to all color channels of the pixel area of the original image data. In this way, the same controlled gain is applied to each color channel without clipping any of the color channels. Accordingly, shift in hue due to color shifting can be avoided.

### Second Example Method (Modified Hard Clipping)

In the second example method, another implementation of the method described above in connection FIG. 3 is performed. As before, in steps S30 and S31, on a pixel area-by-pixel area basis, intensity values, L, are calculated from the color channels of each pixel area of the original image data. In step S31, the intensity value, L, of a pixel area is mapped using an operator to generate a transformed pixel value.

In step, S32, a maximum color channel value is determined from a pixel area of the original digital image data that is the largest of the color channel values. According to this example the following test is applied in steps S32 and S33 to determine whether applying a gain based on the transformed pixel value to the maximum color channel value will generate a color channel value that is above a threshold value. In this example, like the hard clipping shown in FIG. 4, the threshold is the maximum representable value.

In step S33, a check to see if the maximum color channel value will be mapped to a value larger than then the maximum representable value is performed as follows:

Mf(P)>P*max pixel value formula 4
Where M is the maximum color channel value, f(P) is the transformed pixel value generated by applying the operator to the original intensity value, P is the original intensity value, and max pixel value is the maximum value representable by the number of bits available for representing each color channel value. According to formula 4, the product of the maximum color channel value, M, and the transformed pixel value is compared to a product of the intensity value, P, and the maximum representable value, max pixel value. In some implementations the maximum color channel value, M, may be normalized to a range between 0 and 1 in which case the max pixel value in the inequality above may be dropped because it takes the value of one.

If the condition in formula 4 is false, the maximum color channel value will not exceed the maximum representable value and the gain that is a ratio of the transformed pixel value to the original intensity value, f(P) P, is used as a controlled gain. The gain based on the intensity value is applied to all color channel values of the pixel area.

If the condition in formula 4 is true, then the maximum color channel value would exceed the maximum representable value if the gain calculated based on the transformed pixel value is used. Accordingly, a controlled gain is determined as the maximum representable value divided by M, where M is the maximum color channel value. This gain is applied to all color channels of the pixel area and will map the maximum color channel value to the maximum representable value.

The test described in connection with formula 4 has an advantage that it does not include any division. A naïve way of implementing this test would involve calculating the gain by dividing the transformed pixel value, f(P), by the original intensity pixel value, P. However, when implementing embodiments using fixed-function hardware, division operations are typically more expensive than multiplication operations. Accordingly, the test described above is particularly adapted for fast performance in fixed-function hardware.

### Description of Applications

Examples have been given above using R, G, B color data in which each pixel area formed of a pixel or a plurality of pixels in the case of Bayer or other filter array image data has three color channels (Red, Green and Blue). In other embodiments, the techniques may be used with other types of color data, such as C, M, Y color data (Cyan, Magenta, Yellow). The number of color channels is not limited to three and may be two or more color channels.

The embodiments above make reference to an operator being applied. The operator maps a pixel value of the intensity data to a transformed pixel value. The operator depends on the type of processing being applied.

In one example, the operator may perform a local tone mapping. Tone mapping is a technique used in image processing and computer graphics to map one set of pixel intensities to another. This may be done to approximate the appearance of high-dynamic-range (HDR) images in a medium, such as on a display, that has a more limited dynamic range The tone mapping may map a high-dynamic range image to a lower dynamic range in order for the image to be displayable. The tone mapping may be done using local operations (e.g. pixel-by-pixel) in order to preserve more detail and improve appearance.

In another example, a dehaze operator is used that aims to reduce the appearance of haze in digital images. A dehaze algorithm is likely to increase saturation of and contrast between color image pixel values in order to give the impression of reducing haze. Accordingly, such operators may carry a risk of applying a local gain that could cause color channel clipping.

The operators to be applied are not limited to the examples given above and the techniques may be used in any case in which an operator is to be applied to a representative pixel value, such as an intensity value, that may increase color channel values and thereby cause color channel clipping.

### Details of Application to Filter Array Image Data

The above embodiments give the example of R, G, B color image data. Such image data may be image data in a color filter array pattern, such as R, G, B image data in a Bayer array pattern. In such examples, each pixel value in a pixel area only has a single value associated with a particular color in the Bayer array. Other filter array patterns other than Bayer filter pattern are known and the present techniques are equally applicable.

To calculate a luminance value based on color filter array pattern image data, an area of the image data, such as two-by-two or three-by-three pixels may be considered as a pixel area. The representative value may be obtained by taking a weighted average of pixel values across the area. Once a representative value has been obtained, the method may be performed as described above to determine a controlled gain. In cases where the largest color channel value is used, the largest color channel value may be obtained as the largest pixel value within the pixel area.

When the gain is applied to the pixel values in the pixel area, in one example, all the pixel values within the pixel area may be multiplied by the controlled gain determined by the method described above.

In other embodiments, the controlled gain may be determined as a value for the center of the area and, based on controlled gains determined for other surrounding pixel areas, an interpolated gain may be calculated and applied to each pixel value in the pixel area. In such embodiments, the same gain is not applied to each of the color channel values within the pixel area. However, because the controlled gain values are interpolated between adjacent pixel areas, the gain applied is expected to be similar and a noticeable color shift is unlikely to occur.

In other implementations, the pixel area may be selected to be a three-by-three pixel area with a central pixel. The controlled gain may be determined as a value for the central pixel. The methods described above may be repeated on a pixel-area by pixel-area basis with each pixel area being offset from the next by one pixel such that a controlled gain is determined for each central pixel. The calculated controlled gain is only applied to the central pixel in the pixel area after each iteration of the method. In such implementations, the same gain is not applied to each of the color channels in the pixel area. Accordingly, some color shifting may occur. However, such embodiments manage clipping of the color channel and will tend to reduce color shift effects.

What is claimed is:

1. An image processing method that processes digital image data containing a plurality of pixel areas, each pixel area comprising a plurality of color channel values each represented by a predetermined number of bits, the method comprising, for each of the plurality of pixel areas:
calculating a representative pixel value based on two or more of the plurality of color channel values;
applying an operator to the representative pixel value to generate a transformed pixel value;
determining a maximum color channel value that is the largest of the color channel values;
determining a controlled gain so that:
in a case that applying a gain based on the transformed pixel value to the maximum color channel value will generate a color channel value that is below a threshold value, the controlled gain is determined based on the transformed pixel value and the representative pixel value, and
in a case that applying a gain based on the transformed pixel value to the maximum color channel value will generate a color channel value that is above the threshold value, the controlled gain is determined such that the maximum color channel value is mapped to a value representable by the predetermined number of bits; and
applying the controlled gain to at least one of the color channel values in the pixel area.

2. A method according to claim 1, wherein the representative pixel value is a weighted sum of two or more of the color channel values.

3. A method according to claim 1, wherein the threshold value is a maximum value expressible by the predetermined number of bits.

4. A method according to claim 1, wherein in a case that applying a gain based on the transformed pixel value to the maximum color channel value will generate a color channel output value that is above the threshold value, the controlled gain is set to a value that is a ratio of the maximum value representable by the predetermined number of bits divided by the maximum color channel value.

5. A method according to claim 1, comprising determining whether applying a gain based on the transformed pixel value to the maximum color channel value will generate a color channel value that is above the threshold value by comparing one of:
a product of the maximum color channel value and the transformed pixel value to a product of the maximum value expressible by the predetermined number of bits and the representative pixel value, and
a product of the maximum color channel value and the transformed pixel value to the representative pixel value in a case that the maximum color channel value is represented as a normalized value.

6. A method according to claim 5, wherein in a case that one of:
the product of the maximum color channel value and the transformed pixel value is greater than the product of the maximum value expressible by the predetermined number of bits and the representative pixel value, and
the product of the maximum color channel value and the transformed pixel value is greater than the representative pixel value,
it is determined that applying the gain based on the transformed pixel value to the maximum color channel value will generate a color channel value that is above the threshold value.

7. A method according to claim 1, wherein the threshold is lower than the maximum value expressible by the predetermined number of bits.

8. A method according to claim 7, wherein in a case that applying a gain based on the transformed pixel value to the maximum color channel value will generate a color channel output value that is above the threshold value:
an input value is generated based on the maximum color channel value and a gain determined based on the transformed pixel value,
the input value is mapped to an output value, and
the controlled gain is determined based on the output value.

9. A method according to claim 8, wherein the input value is generated as a product of the maximum color channel value and a gain calculated based on the transformed pixel value.

10. A method according to claim 8, wherein the input value is mapped to the output value using at least one selected from a group of: a linear function, a polynomial curve, Bezier spline, a piecewise linear function, a function represented in a look-up table, and an exponential curve.

11. A method according to claim 1 wherein the operator is at least one selected from a group of: a tone mapping operator, and a dehaze operator.

12. A method according to claim 1, wherein the pixel area is a single pixel value including red, green and blue color channels and the representative pixel value is a luma value.

13. A method according to claim 1, wherein the pixel area is one of a two-by-two pixel area and a three-by-three pixel area of filter array image data, each pixel in the pixel area including a single value corresponding to one of a red, green and blue color channel value.

14. A method according to claim 1, wherein applying the controlled gain to the color channel values in the pixel area comprises interpolating controlled gains determined for adjacent pixel areas to determine interpolated gain values for a plurality of pixels in the pixel area and applying the determined interpolated gain values to the pixels in the pixel area.

15. A method according to claim 1, wherein the gain based on the transformed pixel value is determined as a ratio of the transformed pixel value and the representative pixel value.

16. A method according to claim 1, wherein applying the controlled gain comprises applying the controlled gain to each of the color channel values in the pixel area.

17. An image-processing apparatus configured to process digital image data containing a plurality of pixel areas, each pixel area comprising a plurality of color channel values each represented by a predetermined number of bits, the image processing apparatus comprising one or more hardware units configured to, for each of the plurality of pixel areas:
calculate a representative pixel value based on two or more of the plurality of color channel values;
apply an operator to the representative pixel value to generate a transformed pixel value;
determine a maximum color channel value that is the largest of the color channel values;
determine a controlled gain so that:
in a case that applying a gain based on the transformed pixel value to the maximum color channel value will generate a color channel value that is below a threshold value, the controlled gain is determined based on the transformed pixel value and the representative pixel value, and
in a case that applying a gain based on the transformed pixel value to the maximum color channel value will generate a color channel value that is above the threshold value, the controlled gain is determined such that the maximum color channel value is mapped to a value representable by the predetermined number of bits; and
apply the controlled gain to at least one the color channel values in the pixel area.

18. A non-transitory computer-readable storage medium storing instructions that, when executed by a processor of a device, causes the device to perform an image processing method that processes digital image data containing a plurality of pixel areas, each pixel area comprising a plurality of color channel values each represented by a predetermined number of bits, the method comprising, for each of the plurality of pixel areas:
calculating a representative pixel value based on two or more of the plurality of color channel values;
applying an operator to the representative pixel value to generate a transformed pixel value;
determining a maximum color channel value that is the largest of the color channel values;
determining a controlled gain so that:
in a case that applying a gain based on the transformed pixel value to the maximum color channel value will generate a color channel value that is below a threshold value, the controlled gain is determined based on the transformed pixel value and the representative pixel value, and
in a case that applying a gain based on the transformed pixel value to the maximum color channel value will generate a color channel value that is above the threshold value, the controlled gain is determined such that the maximum color channel value is mapped to a value representable by the predetermined number of bits; and
applying the controlled gain to at least one of the color channel values in the pixel area.
